(19) United States
(12) Patent Application Publication
(10) Pub. No.: US 2024/0152546 A1
(43) Pub. Date: May 9, 2024

(54) Processing Diagrams as Search Input

(71) Applicant: Google LLC, Mountain View, CA (US)

(72) Inventors: David Trotter Oleson, Ruschlikon (CH); Sofie Hauge Katan, Zürich (CH); Nils Grimsmo, Wollerau (CH); Mailys Claire Gabrielle Robin, Palo Alto, CA (US); Federico Tombari, Zug (CH)

(21) Appl. No.: 18/502,688

(22) Filed: Nov. 6, 2023

Related U.S. Application Data
(60) Provisional application No. 63/422,562, filed on Nov. 4, 2022.

(51) Int. Cl. G06F 16/532; G06F 16/953

(52) U.S. Cl. CPC G06F 16/532; G06F 16/953

(57) ABSTRACT

Methods and systems for returning search results based on diagrams as search inputs are disclosed herein. One method can include receiving a search request from a user, the search request including an image that depicts a diagram with at least one associated question, and processing the search request using a diagram parsing model to obtain a formal language representation of the diagram. The method can also include providing the formal language representation of the diagram to a search engine as a search query, and receiving, as a search result to the search query, at least one solution to the at least one associated question of the diagram.

### PRIORITY CLAIM

The present application is based on and claims priority to U.S. Provisional Application 63/422,562 having a filing date of Nov. 4, 2022, which is incorporated by reference herein.

### FIELD

The present disclosure relates generally to processing diagrams as search input. More particularly, the present disclosure relates to receiving images of diagrams, such as mathematical problems, geometric figures, and the like, and using these images to provide relevant search results to a user, such as solutions to the problem, equations for assisting in solving the problem, other example problems similar to the input diagram.

### BACKGROUND

Current search algorithms can receive various types of queries, such as text strings, mathematical equations, and the like. However, current search algorithms lack the ability to receive diagrams, or images of mathematical equations, geometric figures, and the like, and provide relevant search results to a user inputting the diagram.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for returning a search result. The method can include receiving a search request from a user, the search request including an image that depicts a diagram with at least one associated question, and processing the search request using a diagram parsing model to obtain a formal language representation of the diagram. The method can also include providing the formal language representation of the diagram to a search engine as a search query, and receiving, as a search result to the search query, at least one solution to the at least one associated question of the diagram.

Another example aspect of the present disclosure is directed to a computer-implemented method for returning a search result. The method can include receiving a search request from a user, the search request including an image that depicts a diagram, and processing the search request using one or more embedding machine-learned models to obtain a textual embedding and an image embedding of the diagram. The method can also include generating a multimodal embedding from the textual embedding and the image embedding and determining a textual search query based on the multimodal embedding. The method can further include providing at least the textual search query to a search engine as a search query and receiving at least one search result from the search engine based on the textual search query.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system according to example embodiments of the present disclosure.

FIG. 1B depicts a block diagram of an example computing device according to example embodiments of the present disclosure.

FIG. 1C depicts a block diagram of an example computing device according to example embodiments of the present disclosure.

FIG. 1D depicts a block diagram of an example model search system according to example embodiments of the present disclosure.

FIG. 2 depicts a block diagram of an example diagram analysis model according to example embodiments of the present disclosure.

FIG. 3A depicts a block diagram of an example multimodal embedding model according to example embodiments of the present disclosure.

FIG. 3B illustrates a block diagram of an example combined query model according to example embodiments of the present disclosure.

FIG. 4 depicts a block diagram of an example diagram parsing model generating a formal language representation of a diagram according to example embodiments of the present disclosure.

FIG. 5 depicts a block diagram of a flow chart for a diagram parsing model parsing an image according to example embodiments of the present disclosure.

FIG. 6 depicts a flow chart diagram of an example method to perform diagram analysis according to example embodiments of the present disclosure.

FIG. 7 depicts a flow chart diagram of an example method to perform diagram analysis according to example embodiments of the present disclosure.

FIG. 8 depicts different examples of input diagrams according to example embodiments of the present disclosure.

Reference numerals that are repeated across plural figures are intended to identify the same features in various implementations.

### DETAILED DESCRIPTION

Overview

Generally, the present disclosure is directed to providing relevant search results when diagrams are received as inputs for a search. Based on the diagram, the relevant search results that can be returned can include a solution for a problem presented in the diagram (including values for various variables), steps for solving the problem presented in the diagram, provide links to relevant equations/theorems/rules/etc., or can provide example problems that are similar to the problem presented in the diagram.

To generate the desired search results, one or more machine-learned models can be used in conjunction with one another. For example, to identify a textual query from a diagram, a multimodal embedding model with one or more encoders (e.g., two encoders, one for images and one for text found in the diagram) can be learned. A classification model (e.g., neural network or other appropriate machine-learned model) can also be learned in parallel to classify the current input. The multimodal encoder and/or the classification model can be trained using supervised training methods from labeled data.

A second approach can include transforming elements of the diagram, such as a geometric shape, into formal language by parsing the diagram. For example, if a diagram of a parallelogram is received, the diagram parser can transform the received parallelogram into a set of formal language descriptions, such as identifying the parallelogram by its vertices (e.g., Parallelogram [A, B, C, D]), identifying which points are connected by line segments, identifying lengths of line segments, and the like. In a second example, an input image from a diagram can include one or more geometric shapes. This image can be pre-processed to remove unwanted markings (e.g., pencil markings from a homework assignment, glare from the photograph of the diagram, and the like) and then input into a geometric entity detection model (using a Hough transform or a machine-learned object detector) and a symbolic detection/math OCR machine-learned object detector. The geometric entity detection model and symbolic detection model can then be used in conjunction to generate a formal language description of the diagram, which can include one or more rules regarding the diagram. For example, based on markings in the diagram, a rule can be generated that one or more line segments have equal length, one or more points lie on the same line segment, one or more line segments are parallel or perpendicular to one another, and the like.

Formal language definitions of the geometric figures and/or mathematical problems in the diagram can then be input into various calculators to solve different problems associated with the diagrams, search out relevant aids such as equations/theorems/etc. to assist in solving problems regarding the diagram, and/or find similar example problems. In some embodiments, relevant search results involving solutions to the problem(s) can include a step-by-step guide for solving the problem, which can enable a better understanding of how the correct solution is reached and help the user more quickly learn and practice concepts illustrated in the diagram, as well as be presented with the underlying equations/theorems for deeper understanding of the concepts. The user can then be presented with similar practice problems so that the concepts can be reinforced.

By performing this processing of diagrams and returning relevant search results for the diagrams, users can quickly and efficiently receive assistance with problems involving such diagrams simply by inputting an image of the diagram into a search engine. This can be especially useful in the modern era of smartphones and other mobile computing devices, as those who require assistance in solving such problems (students, teachers, tutors, and others) can simply take a photograph of a diagram and receive assistance. This leads to time saved manually searching for relevant search results and leads to better quality search results, which inherently saves both processing capability, memory usage, and network bandwidth usage by the user.

With reference now to the Figures, example embodiments of the present disclosure will be discussed in further detail.

### Example Devices and Systems

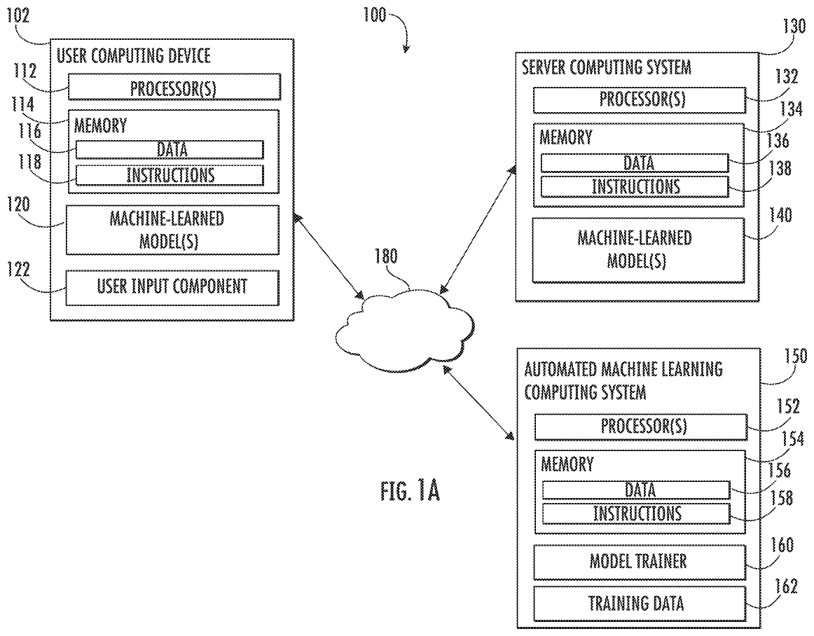

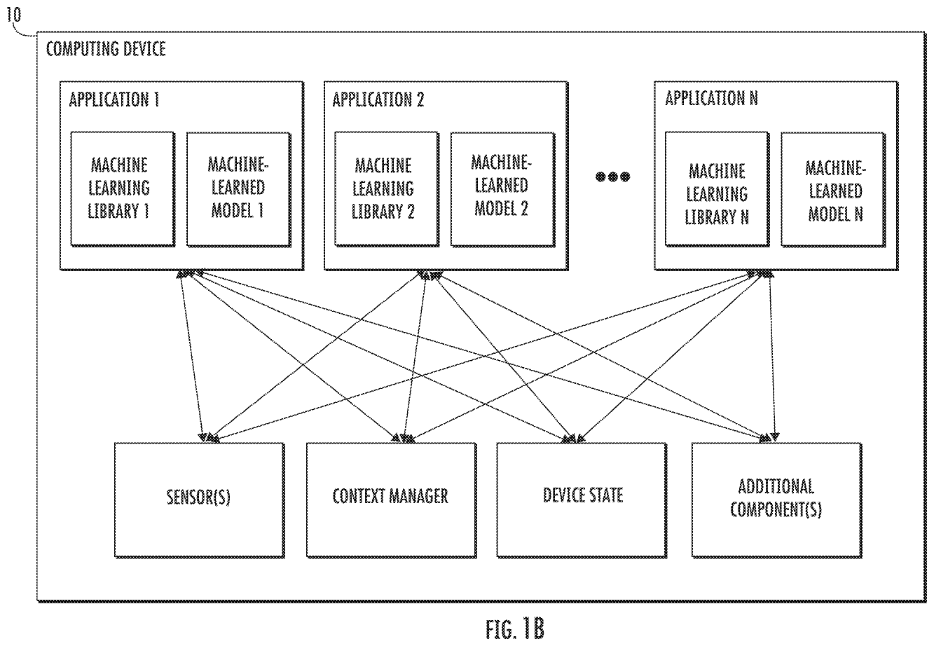

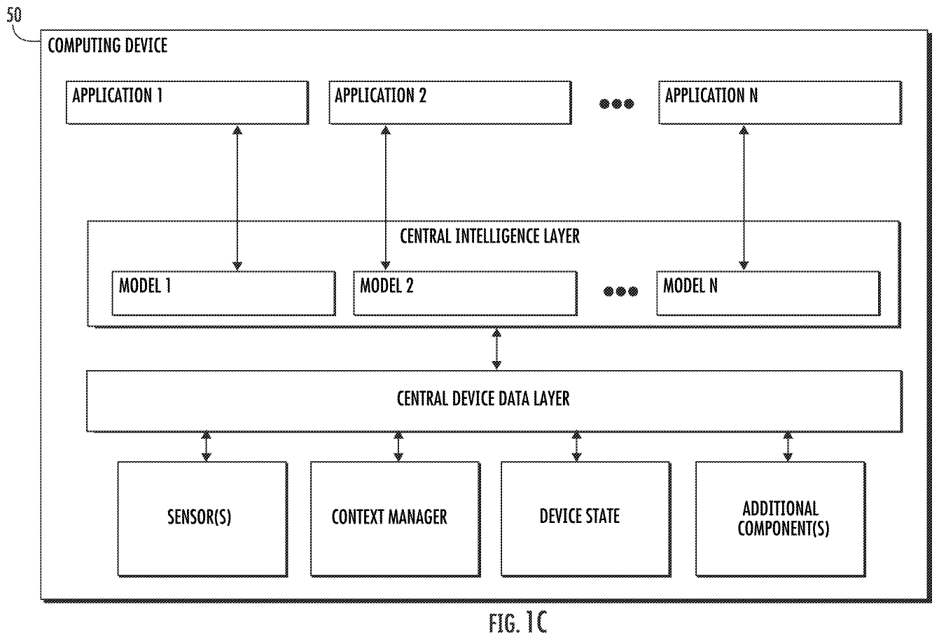

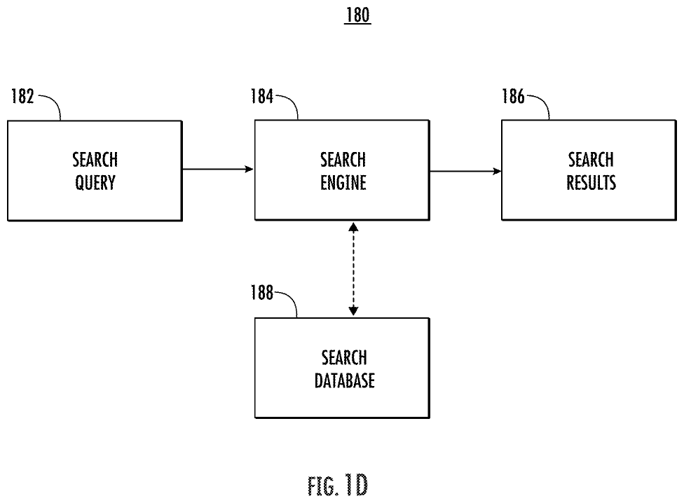

FIG. 1A depicts a block diagram of an example computing system 100 that performs diagram processing according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

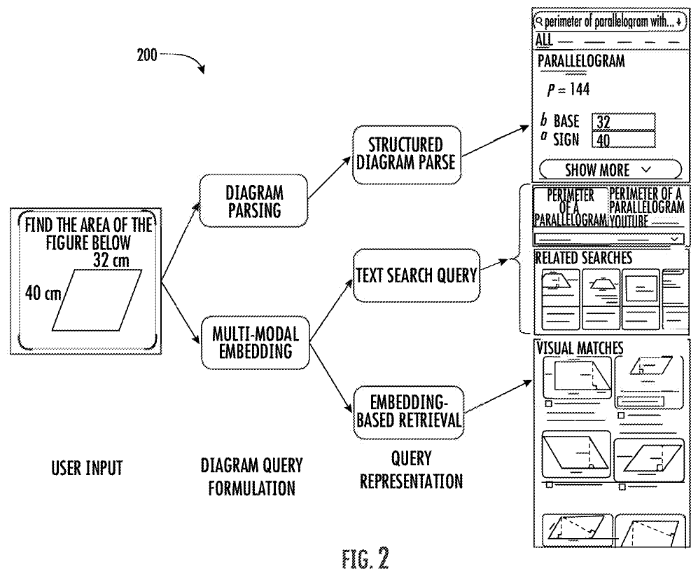

In some implementations, the user computing device 102 can store or include one or more diagram analysis models 120. For example, the one or more diagram analysis models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example diagram analysis models 120 are discussed with reference to FIGS. 2-5.

In some implementations, the one or more diagram analysis models 120 can be received from the server computing system 130 over network 180, stored in the user computing device memory 114, and then used or otherwise implemented by the one or more processors 112. In some implementations, the user computing device 102 can implement multiple parallel instances of a single diagram analysis model 120 (e.g., to perform parallel diagram analysis across multiple instances of diagrams).

More particularly, the one or more diagram analysis models 120 are designed to take as input a diagram and output relevant search results for the diagram. For example, a geometric figure, a circuit diagram, an anatomical drawing, a mathematical problem, a physics diagram, a chemical equation/formula, a molecular model, and/or other diagrams can be input into various diagram analysis models designed for each type of input. The image of the diagram can then be processed by the one or more diagram analysis models 120 (e.g., a multimodal embedding model and/or a diagram parsing model) to generate relevant search results for the diagram in the image. The multimodal embedding model can generate, in some embodiments, a text search query and/or embeddings of the text and images in the diagram. Relevant search results from a multimodal embedding model can include horizontal search features, such as skills, concepts, practice problems, relevant videos, equations, and the like, as well as similar images for identifying similar diagrams to the input diagram. The diagram parsing model can generate a structured diagram parse that includes formal language describing the diagram. This formal language can then be used to generate a solution for the diagram and, in some embodiments, step-by-step instructions for obtaining the solution to problems presented in the diagram.

Additionally or alternatively, one or more diagram analysis models 140 can be included in or otherwise stored and implemented by the server computing system 130 that communicates with the user computing device 102 according to a client-server relationship. For example, the diagram analysis models 140 can be implemented by the server computing system 140 as a portion of a web service (e.g., a diagram analysis service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more diagram analysis models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 2-5.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

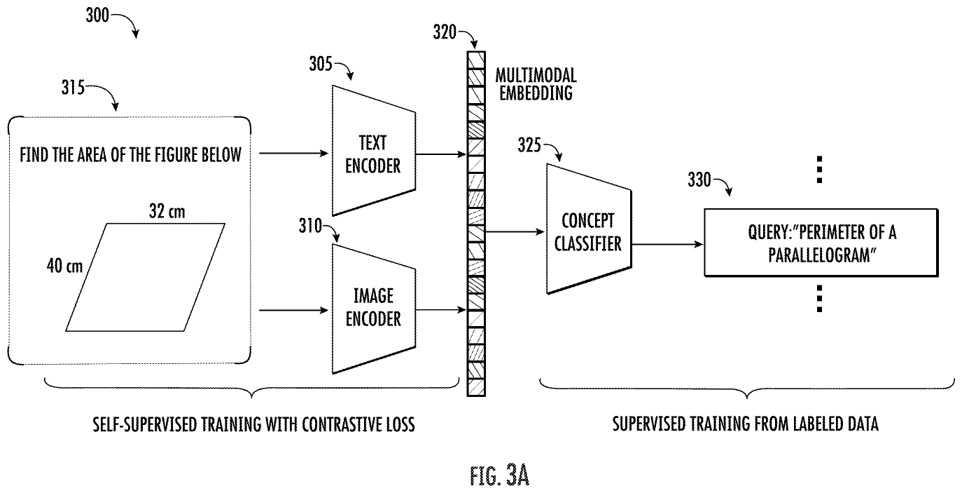

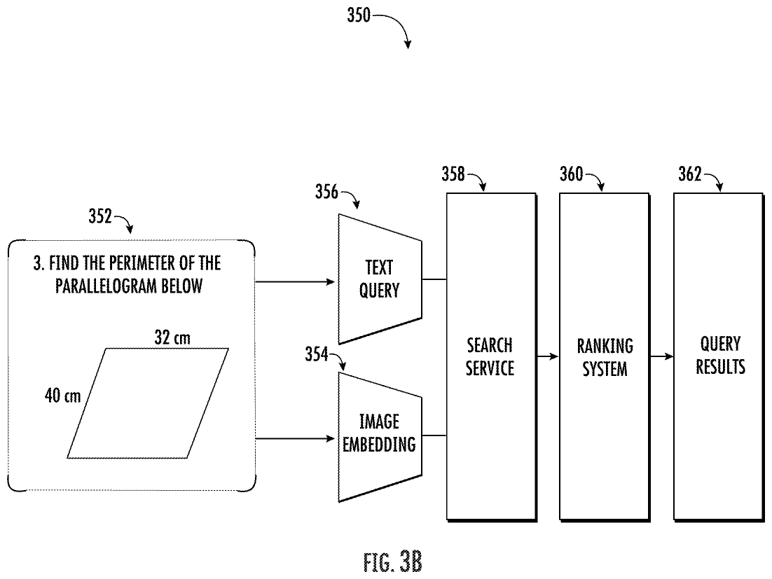

In particular, the model trainer 160 can train the diagram analysis models 120 and/or 140 based on a set of training data 162. The training data 162 can include, for example, labeled diagrams that can be input into the diagram analysis models 120 and/or 140 and then used to perform supervised learning. For example, for a multimodal embedding model (such as described in FIG. 3), a textual encoder and an image encoder can be trained in unison using self-supervised training with contrastive loss. The output of the textual encoder and the image encoder can be concatenated into a single multimodal embedding, which can then be input into a concept classification neural network. This concept classification neural network can then undergo supervised training using the labeled training data to output a textual query associated with the diagram, such as “perimeter of a triangle” or “find the derivative of the following equation.”

In an embodiment, a diagram parsing model can receive labeled diagrams as training data with known formal language definitions of the diagram. For example, for a known square with sides four centimeters in length, a formal language definition can include “Square (A, B, C, D),” “SideLength (4 cm),” and other attributes of the square. The diagram parsing model can be trained on these diagram-formal language pairs using supervised learning.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

FIG. 1D depicts a block diagram of an example model search system 180 according to example embodiments of the present disclosure. In some implementations, the model search system 180 is trained to receive a set of input data 182 descriptive of a search query and, as a result of receipt of the input data 182, provide output data 186 that includes one or more search results. Thus, in some implementations, the model search system 180 can include a search engine 184 that is operable to process a search query and determine intent.

The example model search system 180 can involve a search engine 184 obtaining a search query 182 as input and outputting search results 186 which can include one or more location-specific models. The search query 182 can be a diagram search query associated with a diagram. The search engine 184 can process the query to determine one or more relevant search features associated with the search query 182. The search engine 184 can then access a database 188 to retrieve data related to the diagram. The data, such as relevant equations, practice problems, additional examples, relevant videos, relevant concepts, and the like can be returned as a search result 186. In some implementations, the search results 186 can further include one or more links based on the search query 182 and may include data retrieved from the search database 188.

### Example Model Arrangements

FIG. 2 depicts a block diagram of an example diagram analysis model 200 according to example embodiments of the present disclosure. The diagram analysis model 200 are designed to take as input a diagram and output relevant search results for the diagram. For example, a geometric figure, a circuit diagram, an anatomical drawing, a mathematical problem, a physics diagram, a chemical equation/formula, a molecular model, and/or other diagrams can be input into various diagram analysis models designed for each type of input. The image of the diagram can then be processed by the diagram analysis model 200 (e.g., a multimodal embedding model and/or a diagram parsing model as described below) to generate relevant search results for the diagram in the image. The multimodal embedding model can generate, in some embodiments, a text search query and/or embeddings of the text and images in the diagram. Relevant search results from a multimodal embedding model can include horizontal search features, such as skills, concepts, practice problems, relevant videos, equations, and the like, as well as similar images for identifying similar diagrams to the input diagram. The diagram parsing model can generate a structured diagram parse that includes formal language describing the diagram. This formal language can then be used to generate a solution for the diagram and, in some embodiments, step-by-step instructions for obtaining the solution to problems presented in the diagram.

FIG. 3A depicts a block diagram of an example multimodal embedding model 300 according to example embodiments of the present disclosure. The multimodal embedding model 300 can include a textual encoder 305 and an image encoder 310. Each of the textual encoder 305 and the image encoder 310 can be trained using self-supervised training with contrastive loss. The textual encoder 305 and the image encoder 310 can each generate an embedding based on the input diagram 315. The textual embedding can include information about text in the diagram, and the image embedding can include information about images (e.g., shapes, graphs, etc.) in the diagram.

These embeddings can be combined (e.g., concatenated) into a single multimodal embedding 320. This multimodal embedding 320 can then be passed to a concept classification network 325. The concept classification network 325 can be a neural network or another appropriate form of machine-learned model. Based on the input multimodal embedding 320, the concept classification network can output a query 320 that can be used as a search query to return search results.

In some embodiments, instead of combining a textual embedding and an image embedding, a textual query and an image embedding can be provided to a search service as a combined query. For example, FIG. 3B illustrates a block diagram of an example combined query model 350 according to example embodiments of the present disclosure.

The combined query model 350 can receive, similar to the multimodal embedding model 300, an input 352 that can include both a diagram, such as an equation, geometric figure, circuit diagram, physics diagram, chemical equation, and the like, and text, such as a question or statement related to the displayed diagram. Instead of generating two embeddings, the combined query model 350 can generate an image embedding 354 for the diagram from the input 352 and use optical character recognition (“OCR”) or other methods to identify a text query 356 from the text in the input 352.

The image embedding 354 and the text query 356 can then both be passed as a combined input into a search service 358. The search service 358 can search a corpus of documents using both the text query 356 and the image embedding 358 as queries. In one example, the search service 358 can search a corpus of documents to identify documents with text strings that are similar to the text query 356, such as identifying documents that include text strings relating to “area” and “circle” when the text query 356 includes language such as “find the area of the circle.” The search service 358 can also search the corpus of documents and/or other corpuses of documents to find images with similar embeddings to the image embedding 354. For example, using search techniques such as nearest-neighbor search, images with similar embeddings to the image embedding 354 can be identified and returned as results to the query.

In some embodiments, documents can include both text strings and image embeddings, and the search service 358 can combine the image embedding 354 and the text query 356 to identify documents in the corpus of documents that include both similar text strings and image embeddings to the text query 356 and the image embedding 354, respectively.

After identifying one or more similar documents from the corpus of documents, the search service 358 can return these one or more similar documents as results to the input 352. In some embodiments, ranking system 360 can be used to rank the returned one or more similar documents. For example, the search service 358 can return a plurality of documents having a similarity score (calculated using one or more similarity metrics) that is above a threshold score, and ranking system 360 can then rank the returned documents in descending order from most similar to least similar Other ranking systems, such as nearest-neighbor search or other comparison functions, can also be implemented by the ranking system 360 to determine how related the content of documents

In some embodiments, the corpus of documents can be a large document corpus that includes documents from various disciplines and located in various databases accessible via a web search using the text query 356 and/or the image embedding 354. In some embodiments, the corpus of documents can include a database of educational documents stored in a server accessible by the search service 358, such as an internal database populated with educational documents by an owner of the search service 358.

After similar contents from documents are retrieved by the search service 358 and optionally ranked by ranking system 360, the documents determined to be the most similar can be output as query results 362, which can then be provided back to a user of the computing system utilizing the combined query model 350.

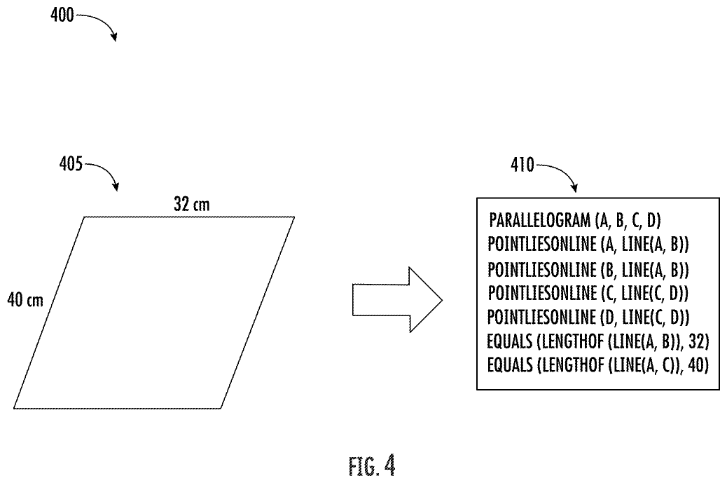

FIG. 4 depicts a block diagram of an example diagram parsing model 400 generating a formal language representation of a diagram according to example embodiments of the present disclosure. The diagram parsing model 400 can receive an input diagram 405 and perform image processing to identify features of the diagram 405. Identified features can then be transformed into a formal language description 410 of each of the features. For example, a parallelogram can be defined as Parallelogram (A, B, C, D) for each vertex of the parallelogram and lengths of line segments constituting the four sides can be defined.

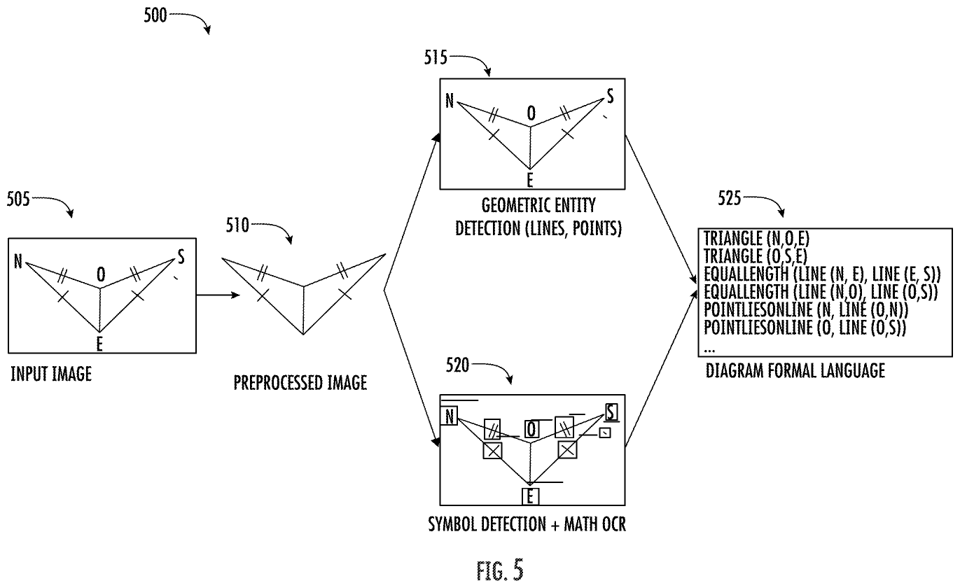

FIG. 5 depicts a block diagram of a flow chart 500 for a diagram parsing model parsing an image according to example embodiments of the present disclosure. The diagram parsing model can receive an input image 505 representing a diagram. Pre-processing 510 can be performed to remove unnecessary artifacts from the input image 505, such as removing any glare from the image, removing unnecessary marks from the image, and the like.

The diagram parsing model can perform geometric entity detection 515. Geometric entity detection 515 can include, for example, identifying geometric entities such as lines and points. In other input types (e.g., electrical circuit diagrams, anatomical diagrams, graphs, and the like), geometric entity identification can be customized to fit the input type, such as being able to identify circuit components by known symbols, identify anatomical parts of a body, identify graph components, and the like. In some embodiments, a machine-learned object detector and/or a Hough transform can be used to perform geometric entity detection.

The diagram parsing model can also perform symbol detection and mathematical recognition 520 using a machine-learned object detector. Symbol detection and mathematical detection can identify known symbols and mathematical quantities in a diagram, such as identifying lines, points, congruency symbols, and other symbols.

The diagram parsing model can also perform text recognition using, for example, OCR or other techniques to identify text that makes up portions of diagrams. For example, the diagram parsing model can recognize text such as “Side AB is seven units in length,” “Circle A has a radius of 10 units,” and other similar textual representations of information in diagrams.

The outputs of geometric entity detection 515 and symbol detection and mathematical recognition 520 can then be combined by the diagram parsing model to generate a formal language representation 525 of the diagram.

### Example Methods

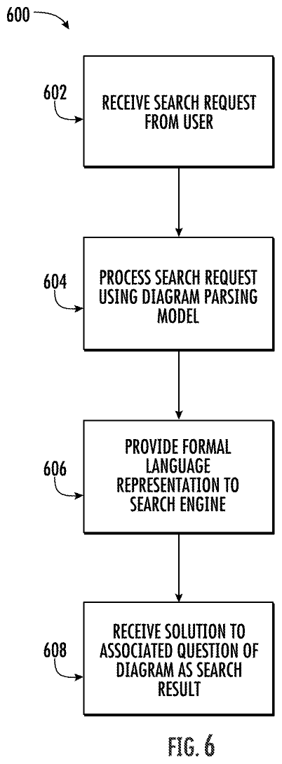

FIG. 6 depicts a flow chart diagram of an example method 600 to perform according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can receive a search request from a user, the search request including an image representing a diagram with at least one associated question. The diagram can include a geometric figure, a circuit diagram, a mathematical equation, a graph, and the like. The one associated question can include questions about the diagram, such as “What is the area of the square” or “what was the median response to the survey?”

At 604, the computing system can process the search request using a diagram parsing machine-learned model to obtain a formal language representation of the diagram. As described above with regards to FIGS. 4 and 5, the diagram parsing machine-learned model can perform processing on the input diagram (such as geometric entity recognition and symbol recognition, among others). The output of the diagram parsing machine-learned model is a formal language representation of the diagram.

At 606, the computing system can provide the formal language representation of the diagram to a search engine as a search query. The search engine can receive the formal language representation as a query and execute a search query to obtain search results.

At 608, the computing system can receive, as a search result to the search query, at least one solution to the at least one associated question of the diagram. Based on the execution of the search query by the search engine, results associated with formal language representation of the diagram can be obtained. These results can include at least a solution to the at least one question, such as providing an area for a square or a median result for the survey.\

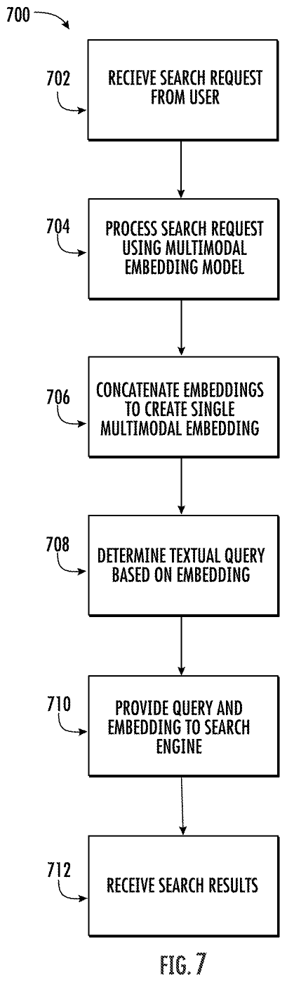

FIG. 7 depicts a flow chart diagram of an example method 700 to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can receive a search request from a user, the search request including an image representing a diagram. The diagram can include a geometric figure, a circuit diagram, a mathematical equation, a graph, and the like. The one associated question can include questions about the diagram, such as “What is the area of the square” or “what was the median response to the survey?”

At 704, the computing system can process the search request using a multimodal embedding machine-learned model to obtain a textual embedding and an image embedding of the diagram. As described above with regards to FIG. 3, embeddings can be generated by trained encoders based on the input diagram. The embeddings can include embeddings indicative of text in the diagram (the textual embedding) and embeddings indicative of images in the diagram (the image embedding).

At 706, the computing system can concatenate the textual embedding and the image embedding to create a multimodal embedding. As described above in FIG. 3, the output textual embedding and the output image embedding can be concatenated into a single multimodal embedding in order to process a single input in a next step.

At 708, the computing system can determine a textual search query based on the multimodal embedding. For example, as described in FIG. 3, a concept classification neural network can receive the multimodal embedding and determine one or more concepts associated with the multimodal embedding. The concept classification neural network can then generate a textual query based on the identified concepts.

At 710, the computing system can provide the textual search query and the multimodal embedding to a search engine as a search query. Both the textual search query and the multimodal embedding can be used as search terms for a search engine. For example, the textual search query can optimally return results with concepts similar to the textual search query, such as providing additional skills, equations, principles, theories, and other information related to the diagram as search results. In contrast, the embedding can be used to obtain similar images to the diagram, which can include similar problems with similar solutions that can then be used as solution aids or as further practice problems for a user.

At 712, the computing system can receive at least one search result based on the textual search query and the multimodal embedding. Based on the results of the search query, a user can be presented with search results obtained from the search query.

Additional Disclosure

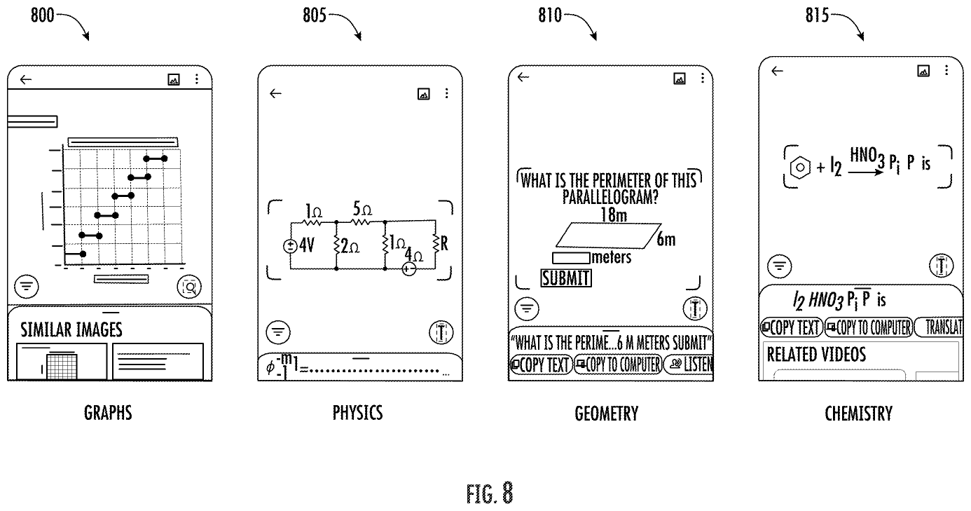

FIG. 8 depicts different examples of input diagrams according to example embodiments of the present disclosure. Input diagrams can include graphs 800, physics diagrams 805, geometry diagrams 810, chemical diagrams 815, and others.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for returning a search result, the method comprising:
receiving a search request from a user, the search request including an image that depicts a diagram with at least one associated question;
processing the search request using a diagram parsing model to obtain a formal language representation of the diagram;
providing the formal language representation of the diagram to a search engine as a search query; and
receiving, as a search result to the search query, at least one solution to the at least one associated question of the diagram.

2. The computer-implemented method of claim 1, wherein the diagram parsing model generates at least a portion of the formal language representation of the diagram by performing geometric entity recognition.

3. The computer-implemented method of claim 2, wherein the geometric entity recognition is performed using at least one of a Hough transformation and a machine-learned object detector.

4. The computer-implemented method of claim 2, further comprising performing pre-processing on the diagram to remove one or more artifacts of the diagram before performing geometric entity recognition.

5. The computer-implemented method of claim 2, wherein performing geometric entity recognition includes identifying one or more geometric features of the diagram.

6. The computer-implemented method of claim 1, wherein the diagram parsing model generates at least a portion of the formal language representation of the diagram by performing symbolic detection using a symbolic detection model.

7. The computer-implemented method of claim 6, wherein the symbolic detection model identifies one or more known symbols in the diagram and outputs at least a portion of the formal language representation of the diagram based on the one or more known symbols.

8. The computer-implemented method of claim 1, wherein the at least one solution includes a step-by-step guide for solving the at least one associated question.

9. The computer-implemented method of claim 1, wherein the formal language representation of the diagram includes at least one feature of the diagram.

10. The computer-implemented method of claim 1, wherein the formal language representation of the diagram includes at least one rule associated with the diagram.

11. A computer-implemented method for returning a search result, the method comprising:
receiving a search request from a user, the search request including an image that depicts a diagram;
processing the search request using one or more embedding machine-learned models to obtain a textual embedding and an image embedding of the diagram;
generating a multimodal embedding from the textual embedding and the image embedding;
determining a textual search query based on the multimodal embedding;
providing at least the textual search query to a search engine as a search query; and
receiving at least one search result from the search engine based on the textual search query.

12. The computer-implemented method of claim 11, wherein the one or more embedding machine-learned models include a textual encoder configured to output the textual embedding and an image encoder configured to output the image embedding.

13. The computer-implemented method of claim 12, wherein the textual encoder and the image encoder are trained in unison using self-supervised training with contrastive loss.

14. The computer-implemented method of claim 11, wherein generating the multimodal embedding includes concatenating the textual embedding and the image embedding into a single embedding.

15. The computer-implemented method of claim 11, wherein determining the textual search query includes inputting the multimodal embedding into a concept classification network and receiving, as an output, the textual search query.

16. The computer-implemented method of claim 15, wherein the concept classification network is trained using supervised training with labeled training data.

17. The computer-implemented method of claim 11, wherein the diagram is a diagram selected from a group of diagrams consisting of a geometric figure, a circuit diagram, an anatomical drawing, a mathematical problem, a physics diagram, a chemical equation, a chemical formula, and a molecular model.

18. The computer-implemented method of claim 11, wherein the textual embedding information about text found in the diagram.

19. The computer-implemented method of claim 11, wherein the image embedding includes information related to one or more images in the diagram.

20. The computer-implemented method of claim 11, wherein the at least one search result includes at least one of an equation, practice problem, relevant video, or a similar image.
